(19) United States
(12) Patent Application Publication
(10) Pub. No.: US 2004/0026447 A1
(43) Pub. Date: Feb. 12, 2004

(54) Any protein and energy powder supplement cold dispensing coin operated vending machine

(76) Inventors: Jeffrey Badin, New York, NY (US); Jose Sulit, New York, NY (US)

Correspondence Address: JEFFREY BADIN / JOSE SULIT, SUITE 185, 666 5 AVE., NEW YORK, NY, 10103, US

(21) Appl. No.: 10/175,024

(22) Filed: Aug. 8, 2002

(51) Int. Cl. B67D 5/56

(52) U.S. Cl. 222/63; 222/129.3

(57) ABSTRACT

A cold powder supplement beverage dispensing device comprising of a removable canister for holding and dispensing powder supplements, a cold water coming from a refrigeration unit, a mixing bowl attach to a mixing chamber and mixing motor to form a protein or a meal replacement or a creatine an energy beverage drink. A drop cup system to capture the drink or beverage as it is dispense from the mixing chamber.

### BACKGROUND OF THE INVENTION

The present invention relates to automatic retailing powder dispensing device. It is common to find vending machines that dispense soda, coffee, pizza, water, energy drinks. Consumer are now aware of health and what they consume as healthy, when they go to a vending machines.

Sports and nutritional drinks and powder meal replacements have become a popular phenomenon. These drinks are used by the diet conscious, health conscious, athletes, those with limited time for meals and others. Today, billions of dollars a year are spent on such drinks.

These drinks come in many different varieties and include brands such as EAS, Muscletech, ProLab, Labrada, MHP, ISS, Optimum Nutrition, Ultimate Nutrition and NextDesigner. Each brand often has several varieties of drinks for discriminating tastes and purposes. Each variation often has different ingredients creating differences in their consistency, density, and thermal properties requiring different recipes.

### SUMMARY OF THE INVENTION

The present invention is a cold powder supplement beverage dispensing device comprising of removable canisters that can have an agitator, an auger runs with auger motor and with a spout for controlling and dispensing powder supplement; a cold water source 5; a mixing bowl 50 in communication with the canister 32 and cold water for combining the powder and water in the mixing chamber 55 to from a beverage drink; an outlet from the chamber to the tube for dispensing the beverage; a drinking cup system for dropping a cup to capture the beverage as it is dispensed from the tube. The device dispenses a cold powder supplement beverage made from combining cold water with a powder supplement ingredient. The beverage is dispensed in quantities for consumption on the premises. The dispenser may be adapted to be place on a counter top or upright or standup on floor.

### BRIFF DESCRIPTION OF DRAWINGS

FIG. 1 is a block diagram of one embodiment of the invention.

FIG. 2 illustrates different embodiments of a canister spout.

### DETAILED DESCRIPTION OF THE INVENTION

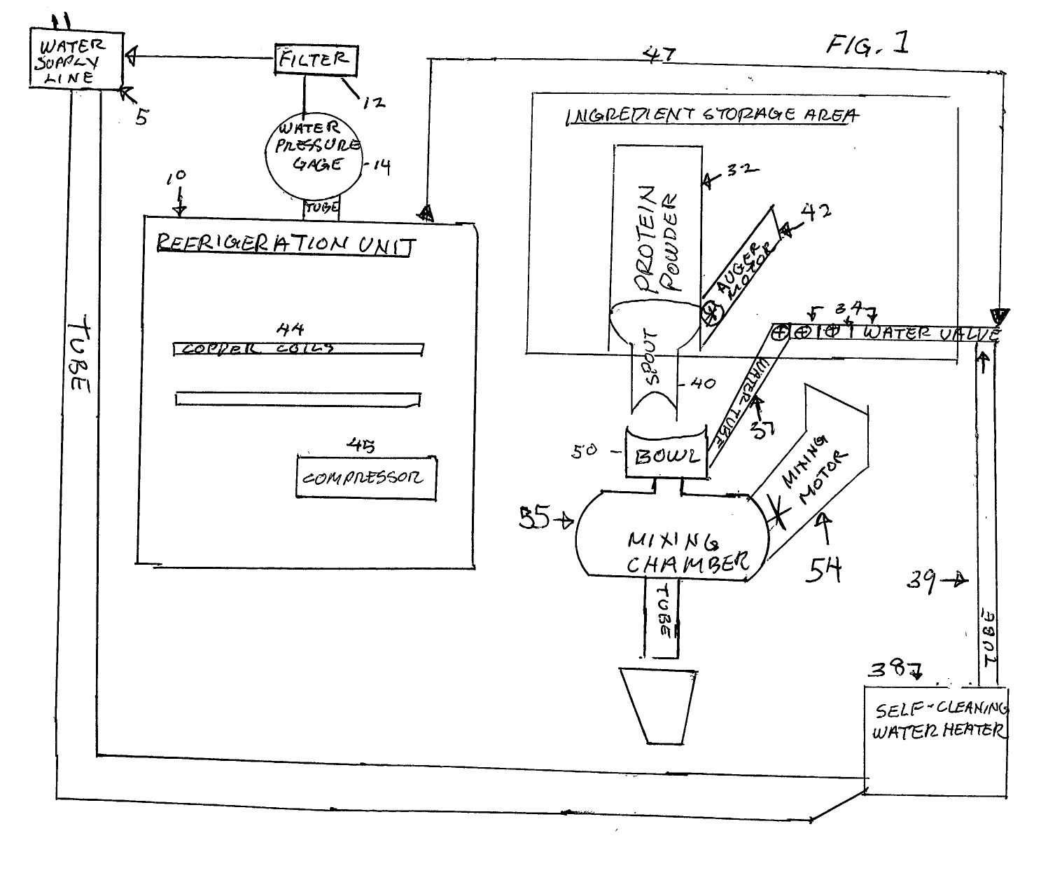

As shown FIG. 1, the dispenser of the preferred embodiment of the present invention contains a refrigeration unit 10, water heater 38, mixing motor 54, mixing chamber 55 auger motor 42, canister 32, water pressure 14 and filter system 12. This water filter, filters the water coming from the main water supply.

Water flows through appropriate tubing from the water filter 12 into the refrigeration unit 10. In the preferred embodiment, water pressure gage 14 is provided to control the flow of water going to the refrigeration unit 10. The refrigeration unit 10 typically comprises of copper coils 44 to cool the water has compressor 45.

The water pressure gage 14 can be adjusted for the appropriate water pressure and maintains the pressure. The preferred temperature is between 40 to 45oF.

The powder supplements are stored in separate canisters 32. The canister 32 should be adapted to maintain the freshness, avoid moisture and contamination with the powder products.

The canisters 32 depending on the model and make are capable of holding between 2 pounds and 3 pounds. With two high or three high canisters it can hold from 4 pounds up to 8 pounds. Some canister can be configure to have an agitator to avoid the powder from sticking on the sides of the canister or building up on top. It also helps push the powder down and out to the spout and into the bowl.

The powder products preferred for the invention are creatine, protein powder and protein meal replacement, glutamine.

The canisters 32 have an auger inside, at the back of the canister is an adapter that can be attached to the auger motor 42 to control the flow of powder for appropriate grams throws.

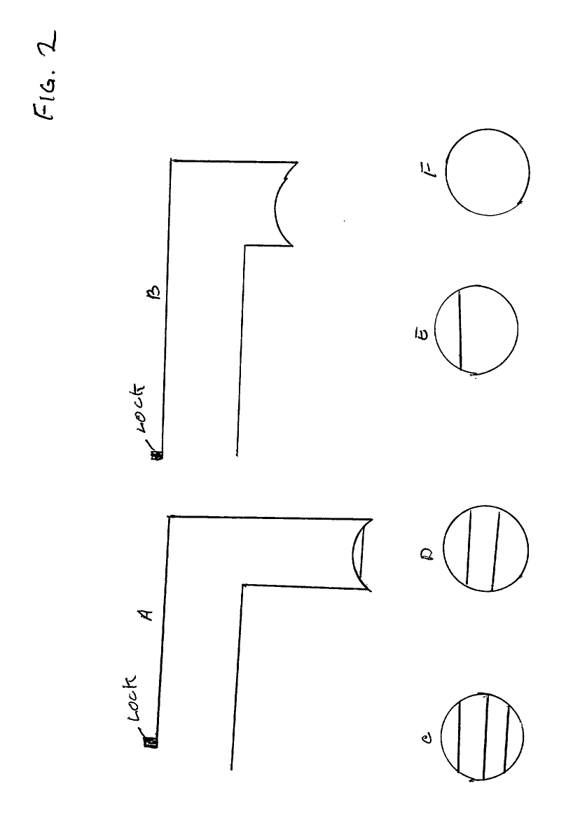

The powder is dispense by running the auger motor 42 which turns or rotate the auger inside the canister that pushes the powder to the spout FIG. 2(a),2(b),2(c),2(d),2(e),2(f) and into the bowl.

The spout can be configure to control the flow of powder. In FIG. 2(a) ,2(b),2(c),2(e),2(f) the spout is simply a circular opening that can be configure as FIG. 2(a),2(b),2(c),2(e),2(f) and can be detached from the canister. Tubing 47 takes the cooled water to the water valves and from the water valves, to another water tube 37 that is connected to the mixing bowl. It supplies cold water into the mixing bowl 50.

Recipes are preprogram to control timing of water flow coming from the water tube 37 from the water valve, timing of the auger motor 42 and timing of the mixing motor 54. The powder is mixed inside a mixing chamber 55 that is attached to the bowl 50 and mixing motor 54.

Example recipe, used for illustration purposes only, includes:

### EXAMPLE 1

Mix 56 grams protein powder with 14 ounces of water. Mixes for 32 seconds of water flow, 35 seconds of auger motor, auger rotations and 38 seconds of mixing motor.

Settings up or programming of recipes are critical to insure proper mixing of powder products. Timing is very important in building the recipes. If timing is not right water will over flow into the cup, to much product coming out of the canister and into the chamber will stop the mixing motor or will over flow the bowl 50 with powder.

The mixing is done inside the mixing chamber 55 and until the powder product is sufficiently mixed. At which point the mixture is dispense from the mixing chamber to flow through the tube and into a cup. In the present invention, comprises of ten bowls 50 to accommodate the varieties of recipes and 10 powder products.

The cup is drop from a cup storage that is controlled by a mechanical device. It drops cup from the storage into a cup holder. Different cups size can be used to provide or accommodate severing size. For example one could purchase a single serving of an 8 ounce drink or a large or double serving of 16 ounces.

A control processor automates the recipes for proper execution. The processor can be programmed to do a self-cleaning cycle that washes the bowls 50, mixing chambers 55 and mixing motors 54. The processor receives the desires input from a touch screen or a push button, i.e. a customer orders an 8 ounces vanilla meal replacement protein. The processor can be controlled from a remote computer or act as a stand alone device. The dispensing device can be a counter top model or a floor unit.

It can have a monitoring system that can detect when canister are low on powder. It can also detect when an error or malfunction inside the device occurs and can send the error, (can produces a dex file) over the net or can be sent over http protocol. The device can be modified base on the need of the customer or base on the requirements of another country. Such modifications are to be considered an included in the following claims unless the claims expressly recite differently.

What is claimed is:

1. A cold powder supplement beverage dispensing device comprising:
a removable canister with auger for holding and dispensing powder supplements.
a cooled water coming from a refrigeration unit.
a mixing bowl in communication with the canister, mixing chamber and
mixing motor for combining the powder and cold water to form a drink

2. A cold powder supplement beverage dispensing device comprising:
a canister with auger that rotates when the auger motor runs to predetermined the flow of powder.

3. A cold powder supplement beverage dispensing device comprising:
a processor can be programmed to make recipes that can control how long the mixing motor runs, the amount of powder per grams and water flow.

4. A powder supplement beverage dispensing device as in claim 1 wherein:
each canister contains a powder selected from the group consisting of creatine, meal replacement, glutamine and protein powder.

5. A powder supplement beverage dispensing device as in claim 1 wherein:
the canister has an agitator preventing the powder from sticking at the side and building up from the top of the canister.

6. A powder supplement beverage dispensing device as in claim 1 wherein:
a processor can programmed to do self-cleaning cycle with hot water to clean water tubes, bowls, mixing chambers and mixing motors.
